(19) United States
(12) Patent Application Publication
(10) Pub. No.: US 2010/0272958 A1
(43) Pub. Date: Oct. 28, 2010

(54) Laminated Composite Products and Methods for Manufacturing the Same

(75) Inventor: William H. Crostic, JR., Simpsonville, SC (US)

Correspondence Address: DORITY & MANNING, P.A., POST OFFICE BOX 1449, GREENVILLE, SC, 29602-1449, US

(73) Assignee: Guardian Building Products, Inc., Greer, SC (US)

(21) Appl. No.: 12/431,331

(22) Filed: Apr. 28, 2009

(51) Int. Cl. B32B 3/10; B32B 27/38; B32B 27/36; B32B 27/30; B32B 27/00; B32B 23/04; B32B 17/04; B29C 47/06

(52) U.S. Cl. 428/151; 428/413; 428/480; 428/522; 428/500; 428/532; 428/432; 264/319

(57) ABSTRACT

In accordance with one embodiment of the present disclosure a laminated composite product is provided. The product comprises a composite base, the composite base including filler material and a thermoplastic material. The product further comprises a surface layer extruded on at least a portion of the base, the surface layer being non-adhesively joined to the composite base and including about 0.1 weight percent to about 10 weight percent pigment.

### BACKGROUND

Wood composites are increasingly being utilized as a replacement material for traditional solid wood products. Wood composites generally contain wood or other filler material and thermoplastic polymers. Such composites are formed for use in many of the same applications as a solid wood product while offering advantages such as high resistance to insect penetration and moisture damage.

Conventional wood composites include various additives to add color and protect against mildew, ultraviolet light exposure, discoloration or the like. However, additives can be very expensive, particularly when they are incorporated throughout the entire wood composite. In an effort to decrease the usage of such materials, multi-layer wood composite products have been utilized. Multi-layer wood composite products can include a substrate layer with a cap layer disposed on at least one surface of the substrate layer. By limiting the additives to the cap layer, costs can be reduced while still providing the desired protection. However, conventional methods of forming multi-layer wood composite products are still lacking with respect to efficiency and cost savings.

For example, multi-layer products are often formed utilizing co-extrusion methods in which extrudates are extruded through separate orifices of a single die and merged to form multiple layers. Unfortunately, such co-extrusion methods are very costly and can still result in excess material being utilized for the cap layer(s).

Thus, a need exists for methods of forming composite products that are efficient and cost-effective. Composite products formed by utilizing such methods would be particularly beneficial.

### SUMMARY

Objects and advantages of the invention will be set forth in part in the following description, or may be obvious from the description, or may be learned through practice of the invention.

In accordance with one embodiment of the present disclosure a laminated composite product is provided. The product comprises a composite base, the composite base including filler material and a thermoplastic material. The product further comprises a surface layer extruded on at least a portion of the base, the surface layer being non-adhesively joined to the composite base and including about 0.1 weight percent to about 10 weight percent pigment.

In another embodiment of the present disclosure a method for making a laminated composite product is provided. The method includes extruding a mass comprising filler material and thermoplastic resin to form a composite base, heating at least a portion of the outer surface of the composite base, and extruding a layer onto at least a portion of the heated outer surface of the composite base resulting in the layer being non-adhesively joined to the composite base to form a laminated composite product.

Other features and aspects of the present disclosure are discussed in greater detail below.

### BRIEF DESCRIPTION OF THE DRAWINGS

A full and enabling disclosure, including the best mode thereof, directed to one of ordinary skill in the art, is set forth more particularly in the remainder of the specification, which makes reference to the appended figure in which:

FIG. 1 is a perspective view of a composite product in accordance with certain embodiments of the present disclosure; and

FIG. 2 is a schematic view of a system that can be used in accordance with certain embodiments of the present disclosure.

Repeat use of reference characters in the present specification and drawings is intended to represent same or analogous features or elements of the disclosure.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and their equivalents.

The present disclosure is generally directed to methods for making laminated composite products. The methods include extruding a mass comprising filler material and thermoplastic resin to form a composite base, heating at least a portion of the outer surface of the composite base, and extruding a layer onto at least a portion of the heated outer surface of the composite base resulting in the layer being non-adhesively joined to the composite base to form a laminated composite product.

Additionally, the present disclosure describes a laminated composite product having a composite base formed from filler material and thermoplastic material. A surface layer is extruded on at least a portion of the base. The surface layer is non-adhesively joined to the composite base and includes about 0.1 weight percent to about 10 weight percent pigment.

The methods described herein do not require the use of expensive and inefficient co-extrusion processes. Rather, the present methods allow for a very thin surface layer to be extruded onto the surface of a pre-formed composite base, thereby decreasing the costs required for expensive additives. Such a process can significantly decrease the amount of additives required to form a composite product while still resulting in a product that does not delaminate over time. For instance, the methods of the present disclosure can be utilized to form a composite base without any pigments being utilized. Rather, the pigments can be added to the surface layer which is extruded onto the surface of the composite base providing an aesthetically pleasing appearance to the composite product while reducing the amount of pigment necessary. In this manner, the present methods are more cost-effective and efficient than conventional methods.

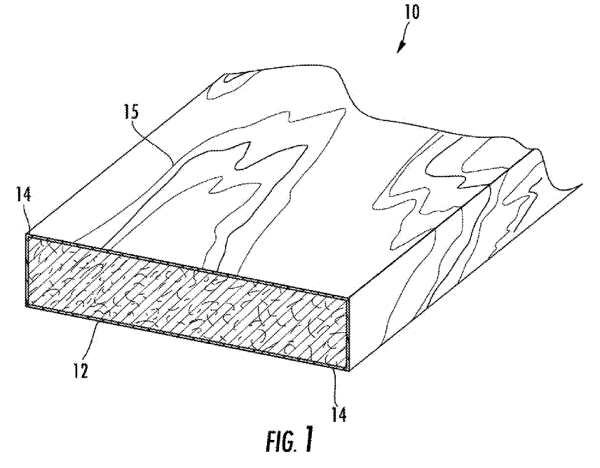

Referring to FIG. 1, a composite product in accordance with one embodiment of the present disclosure is illustrated. The composite product can be a composite wood product that is particularly contemplated for use in decking applications, as illustrated by the composite product 10 of FIG. 1. However, the products described herein are equally suitable for other applications, including, but not limited to, siding, floor tiles, paneling, moldings, steps, door and window sills and sashes, outdoor furniture, fencing, playground equipment, posts and barn components, and marine items such as decking, bulkheads and pilings, and the like. In this regard, the composite product can have suitable dimensions as would be known in the art. For example, for decking applications, the composite product can be formed to standard sizes.

The composite product 10 includes a composite base 12 that generally contains about 35 weight percent to about 65 weight percent filler material, more particularly from about 40 weight percent to about 50 weight percent filler material, and still more particularly from about 45 weight percent to about 50 weight percent filler material. In this regard, filler material can include cellulosic fiber, glass fiber, glass spheres, graphite fiber, or combinations thereof. Preferably, the filler material can include fibers that are cellulosic and derived from recycled paper products, such as agrifibers, pulp, newsprint, soft woods, such as pine, or hard woods from deciduous trees. Hard woods are generally preferred for fiber manufacture because they absorb less moisture, can cost less than other wood types, and can contribute more structural value to the composite product. In embodiments in which hard wood is utilized as the primary source of fiber, additional fiber make-up can be derived from secondary sources including soft wood fibers, natural fibers including bamboo, rice hulls, sugar cane, and recycled or reclaimed fiber from newspapers, cardboard boxes, or the like, and combinations thereof. However, it should be understood that the fibers can also be non-cellulosic as described above.

The composite base 12 also generally contains a thermoplastic material. For instance, the thermoplastic material can be present in an amount of about 35 weight percent to about 55 weight percent, more particularly from about 40 weight percent to about 50 weight percent thermoplastic material, and still more particularly from about 45 weight percent to about 50 weight percent thermoplastic material. The thermoplastic material can be a virgin material, a recycled material or a mixture of virgin and recycled material, although recycled material is preferred. Preferably, the thermoplastic material can be a thermoplastic resin and can include a polyolefin or copolymer thereof, such as polypropylene, and may be entirely polypropylene. However, other suitable thermoplastic resins can be utilized in combination with or separately from polypropylene. For example, polyvinyl chloride, polyethylene, nylon, polyesters, polysulfones, polyphenylene oxide and sulphide, epoxies, cellulosics, and combinations thereof are also suitable thermoplastic resins that can be used in connection with the present disclosure.

In certain embodiments, the composite base 12 can also include one or more additional additives. For example, coupling agents, impact modifiers, thermal stabilizers, reinforcing agents, lubricants, plasticizers, organic and inorganic pigments, UV stabilizers, filler material, biocides, processing aids, flame retardants, and combinations thereof can all be utilized in connection with the present disclosure. Such additives can be individually present in an amount from about 0.5 weight percent to about 5 weight percent, although certain additives are more advantageously located in the surface layer 14.

The thickness of the composite base 12 can vary depending on the particular application of the composite product. In certain embodiments, the base 12 can have a thickness of about 10 millimeters to about 60 millimeters, particularly from about 20 millimeters to about 55 millimeters thickness, more particularly, about 25 millimeters thickness. The thicknesses can vary as would be understood by one skilled in the art depending upon application for the composite product.

In addition, the composite product 10 includes an extruded surface layer 14 formed on at least a portion of the composite base 12. The surface layer 14 is non-adhesively joined to the composite base 12. The surface layer 14 can contain from about 45 weight percent to about 75 weight percent thermoplastic material, more particularly from about 60 weight percent to about 70 weight percent thermoplastic material, and still more particularly from about 65 weight percent to about 70 weight percent thermoplastic material. The thermoplastic material can be a virgin material, a recycled material or a mixture of virgin and recycled material, although virgin material is preferred. Again, preferably the thermoplastic material can be a thermoplastic resin such as a polyolefin or copolymer thereof. A suitable example is polypropylene (and may be entirely polypropylene) but any suitable thermoplastic resin as described herein is contemplated by the present disclosure.

The surface layer 14 further includes one or more pigments. The pigment is present in the surface layer 14 in an amount of about 0.1 weight percent to about 15 weight percent, particularly from about 1 weight percent to about 10 weight percent, more particularly from about 1 weight percent to about 3 weight percent. In this regard, suitable pigments can include organic and inorganic pigments as would be known in the art. It has been determined that the surface layer 14 can beneficially provide color to the composite product 10 utilizing a fraction of the pigment that would be required in conventional products. The surface layer 14 can serve to cover the composite base 12, thereby minimizing the amount of pigment required in the composite base 12. For instance, suitable pigments can include color-fast and/or UV stable pigments such as iron oxide based pigments. In certain embodiments, an IR-reflective pigment can be utilized to reduce the heat build-up from sunlight in decking applications.

In certain embodiments, the surface layer 14 can also include one or more additional additives. For example, UV stabilizers, filler material, biocides, processing aids, flame retardants, and combinations thereof can all be utilized in connection with the surface layer 14. Such additives can be individually present in an amount from about 1 weight percent to about 60 weight percent, depending on the additive(s) selected.

For example, surface layer 14 can include aluminum oxide, talc, calcium carbonate, or combinations thereof. A common problem with laminated composite products is that the exterior surface layer can have a so-called “plastic” appearance and can wear easily. Additives such as aluminum oxide can greatly reduce the “plastic” appearance and can also significantly improve wear while improving thermal stability.

The surface layer 14 can have a thickness of about 0.01 millimeters to about 0.5 millimeters, particularly from about 0.01 millimeters to about 0.1 millimeters. Additionally, the surface layer 14 can have surface designs 15 present. For instance, in certain embodiments, the surface design 15 can simulate wood grain. However, other patterns can also be utilized for surface design 15 if desired. Furthermore, the surface layer 12 can be present on one or more surfaces of the composite base 12. A surface can refer to any surface of composite base 12 including the top surface, bottom surface, or one or both side surfaces. In certain embodiments, the surface layer can completely wrap the composite base.

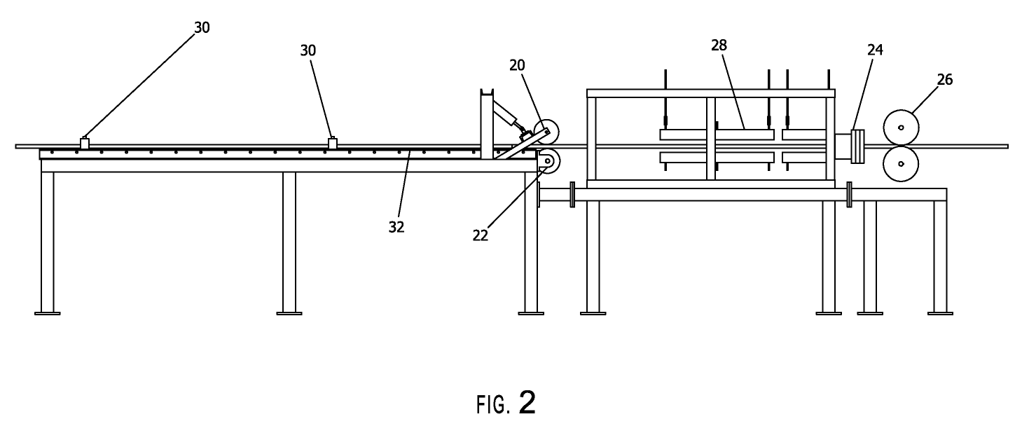

Turning to FIG. 2, methods for manufacturing composite products in accordance with the present disclosure will be discussed in more detail. The methods can be carried out in a single manufacturing line so as to form the completed composite product.

The composite base of the present disclosure is formed by extrusion processes (not illustrated). Such extrusion processes are generally well known in the art. It is generally preferred that the materials forming a mass of materials are present in pelletized form. As discussed above, in addition to the filler material and thermoplastic material, various additives can also be added to the mass of materials prior to extrusion. All of the various materials added to the mass of materials should be present in a size and shape sufficient to form a composite product having the characteristics described herein.

A blowing agent or gas can also be added to the mass to reduce the density and weight of the composite product by foaming. If a blowing agent is utilized, it is mixed into the mass during blending or at the extruder inlet. In the extruder, the blowing agent is decomposed, disbursing gas, such as nitrogen or CO₂, into the melt. As the extrudate exits the extrusion die, the gas sites experience a pressure drop expanding into small cells or bubbles trapped by the surrounding polymer. This allows the composite product to have a significantly decreased weight.

For example, in certain embodiments, the composite base can be formed by introducing materials including respective quantities of a filler material and thermoplastic material into the inlet of an extruder. Preferably, the weigh blender is positioned immediately above the extruder, at the extruder inlet, so that the mass of materials is formed immediately prior to entering the extruder, thus minimizing or preventing separation of the materials. The materials are then extruded at temperatures and pressures as would be known in the art through the extruder barrel and out the extrusion die to form the composite base. The composite base can be extruded into any suitable shape and/or size depending upon the intended application. After extrusion, the composite base can be permitted to cool or can be cooled by any suitable method as would be known in the art.

After the composite base is formed, it is heated at a temperature ranging from about 250° F. to about 375° F., more particularly from about 300° F. to about 400° F., still more particularly from about 315° F. to about 360° F. The composite base can be heated through IR heaters 28 via nip roller(s) 20, drive roller(s) 22, and vertical rollers 30 along surface 32 to bring at least a portion of the surface of the board to a molten state. However, any suitable method of heating composite base can be utilized as would be known in the art.

Next, composite base proceeds into a die 24. Die 24 can be heated so as to continue the surface melting process of composite base. Die 24 is configured to accommodate the composite base so that a layer is extruded onto the heated outer surface within the die 24. Die 24 defines a cavity having a circumference that is about 0.01 millimeters to about 0.5 millimeters larger than the circumference of the composite base. A blend of layer and composite base takes place at the interface of the materials. As the layer is extruded into the die cavity and onto the composite base, the speed of the composite base as it is being fed through die 24 can be matched to the extrusion rate. Layer is extruded using conventional methods as previously described herein. The die 24 can be configured so as to permit one or more surfaces of composite base 12 to be exposed to the extrudate used to form layer. After extrusion onto composite base, layer forms a non-adhesive bond with composite base resulting in a composite product.

As the composite product exits die 24, layer and/or the composite base can be embossed to ensure optimal adhesion and improve the surface of the board. In certain embodiments, a suitable embossing device 26 can be utilized to form a desired surface design in the composite product. For instance, in certain embodiments, the surface design can simulate wood grain. However, other patterns can also be utilized if desired. The embossing device 26 can emboss one or more of the top, bottom, or side surfaces of the composite base and/or surface layer, either in combination or alone.

Once the composite product has been formed, it can be cut to a desired length by a conventional cutter (not illustrated) and packaged for shipment. In this regard, boards of composite base are typically fed into die 24 butt to butt and since layer can be continuous formed, a double parallel saw can be utilized to cut the boards at the butt line to separate the individual boards that have been joined together by layer. Cut scrape can be recycled into substrate.

It should be understood that variations can be made in the above-described process that are within the scope and spirit of the present disclosure. It will be appreciated that the inventive method described herein allows for the formation of composite products having properties which greatly resemble the properties of natural wood while having much fewer additives than conventional products.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure so further described in such appended claims.

What is claimed is:

1. A laminated composite product comprising:
a composite base, the composite base comprising filler material and a thermoplastic material; and
a surface layer extruded on at least a portion of the base, the surface layer being non-adhesively joined to the composite base and comprising about 0.1 weight percent to about 15 weight percent pigment.

2. The laminated composite product of claim 1, wherein the thermoplastic material comprises polypropylene, polyvinyl chloride, polyethylene, nylon, polyesters, polysulfones, polyphenylene oxide, polyphenylene sulphide, epoxies, cellulosics, or combinations thereof.

3. The laminated composite product of claim 1, wherein the thermoplastic material is present in an amount of about 35 weight percent to about 55 weight percent.

4. The laminated composite product of claim 1, wherein the filler material comprises cellulosic fiber, glass fiber, glass spheres, graphite fiber, or combinations thereof.

5. The laminated composite product of claim 1, wherein the filler material comprises cellulosic fiber.

6. The laminated composite product of claim 1, wherein the filler material is present in an about of about 35 weight percent to about 65 weight percent.

7. The laminated composite product of claim 1, wherein the pigment is present in an amount of about 1 weight percent to about 10 weight percent.

8. The laminated composite product of claim 1, wherein the surface layer further comprises aluminum oxide, talc, calcium carbonate, or combinations thereof.

9. The laminated composite product of claim 1, wherein the surface layer further comprises aluminum oxide.

10. The laminated composite product of claim 1, wherein the surface layer includes a wood grained pattern.

11. A method for making a laminated composite product comprising:
extruding a mass comprising filler material and thermoplastic resin to form a composite base;
heating at least a portion of the outer surface of the composite base; and
extruding a layer onto at least a portion of the heated outer surface of the composite base resulting in the layer being non-adhesively joined to the composite base to form a laminated composite product.

12. The method of claim 11, further comprising embossing at least a portion of the laminated composite product.

13. The method of claim 11, wherein the layer is extruded through a die, the die configured to accommodate the composite base so that the layer is extruded onto the heated outer surface within the die.

14. The method of claim 13, wherein the die is heated.

15. The method of claim 13, wherein the die defines a cavity having a circumference that is about 0.01 millimeters to about 0.5 millimeters larger than the circumference of the composite base.

16. The method of claim 11, wherein the thermoplastic material comprises polypropylene, polyvinyl chloride, polyethylene, nylon, polyesters, polysulfones, polyphenylene oxide, polyphenylene sulphide, epoxies, cellulosics, or combinations thereof.

17. The method of claim 11, wherein the filler material comprises cellulosic fiber, glass fiber, glass spheres, graphite fiber, or combinations thereof.

18. The method of claim 11, wherein the layer comprises about 0.1 weight percent to about 15 weight percent pigment..

19. The method of claim 18, wherein the layer further comprises aluminum oxide, talc, calcium carbonate, or combinations thereof.

20. The method of claim 11, wherein the layer is a virgin layer.
